(19) United States
(12) Patent Application Publication
(10) Pub. No.: US 2023/0300703 A1
(43) Pub. Date: Sep. 21, 2023

(54) CELL SWITCHING METHOD AND APPARATUS, STORAGE MEDIUM, AND ELECTRONIC DEVICE

(71) Applicant: YULONG COMPUTER TELECOMMUNICATION SCIENTIFIC (SHENZHEN) CO., LTD, Shenzhen (CN)

(72) Inventor: Jun JIN, Shenzhen (CN)

(73) Assignee: YULONG COMPUTER TELECOMMUNICATION SCIENTIFIC CO., LTD, Shenzhen (CN)

(21) Appl. No.: 18/021,115

(22) PCT Filed: Dec. 15, 2020
(86) PCT No.: PCT/CN2020/136614

§ 371 Date: Feb. 13, 2023

(30) Foreign Application Priority Data
Sep. 21, 2020 (CN) 202011000294.X

(51) Int. Cl. H04W 36/14; H04W 36/24; H04W 36/02; H04W 36/00

(52) U.S. Cl. CPC H04W 36/14; H04W 36/24; H04W 36/023; H04W 36/0085

(57) ABSTRACT

Provided are a cell switching method and apparatus, a storage medium, and an electronic device, which belongs to the field of communication technologies. The cell switching method includes the following: the data amount of the data to be transmitted is determined, the cell type of the serving cell is acquired when the amount of data is less than the data volume threshold, and the serving cell is switched to a non-5G cell when the cell type of the serving cell is a 5G cell.

### CROSS-REFERENCE TO RELATED APPLICATIONS

This is a National Stage Application, filed under 35 U.S.C. 371, of International Patent Application No. PCT/CN2020/136614, filed on Dec. 15, 2020, which claims priority to Chinese Patent Application No. 202011000294.X, filed with the China National Intellectual Property Administration (CNIPA) on Sep. 21, 2020, disclosures of which are incorporated herein by reference in their entireties.

### TECHNICAL FIELD

The present disclosure relates to the technical field of communications, specifically, a cell switching method and apparatus, a storage medium, and an electronic device.

### BACKGROUND

At present, from the perspective of the development trend of wireless communication technologies, enhance mobile broadband (eMBB), ultra reliable low latency communications (URLLC) and massive machine type communications (mMTC) have become three important application scenarios for the fifth-generation mobile networks (5G) technology. The 5G network may bring a higher bandwidth rate, a lower and more reliable delay, and a larger capacity network connection to users, but due to the excessive power consumption of 5G base stations and terminals in the related art, the terminals cannot meet the existing requirements in terms of battery life.

### SUMMARY

Embodiments of the present application provide a cell switching method and apparatus, a storage medium, and an electronic device, which can save the power consumption of terminal devices and increase the time of endurance. The technical schemes are as follows:

Embodiments of the present application provide a cell switching method, and the method includes the following steps.

A data amount of data to be transmitted is determined;
when the data amount is less than a data amount threshold, a cell type of a serving cell is acquired; and
when the cell type of the serving cell is a 5G cell, the serving cell is switched to a non-5G cell.

Embodiments of the present application provide a cell switching apparatus, and the apparatus includes a determination module, an acquisition module, and a switching module.

The determination module is configured to determine a data amount of data to be transmitted.

The acquisition module is configured to acquire a cell type of a serving cell, when the data amount is less than a data amount threshold.

The switching module is configured to switch the serving cell to a non-5G cell, when the cell type of the serving cell is a 5G cell.

Embodiments of the present application provide a computer storage medium, the computer storage medium stores multiple instructions, and the instructions are suitable for being loaded by a processor and performing the steps of the above method.

Embodiments of the present application provide an electronic device including a memory and a processor. The memory stores a computer program, and the computer program is suitable for being loaded by the processor and performing the method steps described above.

The technical scheme provided by some embodiments of the present application brings at least the following beneficial effects:
when the above cell switching method and apparatus, storage medium, and electronic device operate, the data amount of the data to be transmitted is determined, the cell type of the serving cell is acquired when the data amount is less than the data amount threshold, and the serving cell is switched to the non-5G cell, when the cell type of the serving cell is the 5G cell. By switching a 5G cell to a non-5G cell without necessary situations, the terminal device reduces the excessive power consumption caused by continuous connection to the 5G cell without considering actual requirements in the related art, which can save terminal power consumption and increase the time of endurance.

### BRIEF DESCRIPTION OF DRAWINGS

In order to more clearly illustrate the embodiments of the present application or the technical solution in the prior art, the following will be a brief introduction to the drawings required in the embodiment or prior art description, obviously, the drawings described below are only some embodiments of the present application, for those of ordinary skill in the art, without the premise of creative labor, may also obtain other drawings according to these drawings.

FIG. 1 is a schematic diagram of a communication system architecture provided by an embodiment of the present application;

FIG. 2 is a schematic diagram of the flow of a cell switching method provided by an embodiment of the present application;

FIG. 3 is another flow chart of a cell switching method provided by an embodiment of the present application;

FIG. 4 is a schematic view of the structure of a cell switching apparatus provided by an embodiment of the present application; and

FIG. 5 is a schematic diagram of the structure of an electronic device provided by an embodiment of the present application.

### DETAILED DESCRIPTION

In order to make the purpose, technical solution and advantages of the present application clearer, the embodiment of the present application will be further described in detail in conjunction with the accompanying drawings.

In the following description, the same numbers in different drawings represent the same or similar features when designing drawings, unless otherwise indicated. The embodiments described in the following example embodiments do not represent all embodiments consistent with the present application. Rather, they are only examples of apparatus and methods consistent with some aspects of the present application as detailed in the attached claims.

In the description of the present application, it is to be understood that the terms “first”, “second”, etc. are only for descriptive purposes and cannot be understood as indicating or implying relative importance. For those of ordinary skill in the art, the specific meaning of the above terms in the present application may be understood in a case-by-case situation. “and/or”, which describes the association relationship of associated objects, means that there can be three relationships, for example, A and/or B, that is, A alone, A and B at the same time, and B alone.

The character “I” generally indicates that the associated objects have an “or” relationship.

Embodiments of the present application may be applied to a wireless communication system, it should be noted that the wireless communication system mentioned in embodiments of the present application includes, but is not limited to, the fourth-generation mobile communication (4G) mobile communication system and the three application scenarios of the next generation of mobile communication system, including enhanced mobile broadband (eMBB), URLLC, and massive machine-type communications (mMTC).

FIG. 1 is a schematic diagram of a communication system architecture provided in the present application.

Referring to FIG. 1, the communication system 01 includes a network device 101 and a terminal device 102, and when the communication system 01 includes a core network, the network device 101 may also be connected to the core network. The network device 101 may also communicate with an Internet protocol (IP) network 200, e.g., the Internet, a private IP network, or other data networks, and the network device provides services for terminal devices within the coverage. The network device 101 provides the wireless access to one or more terminal devices within the coverage of the network device 101. In addition, network devices may communicate with each other.

The network device 101 may be a device for communicating with the terminal devices and a tracker. This network device may be a relay station, an access point, an in-vehicle device, etc. In a terminal device to device (D2D) communication system, the network device may also be a terminal device that functions as a base station.

The terminal device 102 includes, but is not limited to, a mobile station (MS), a mobile terminal, a mobile telephone, a handset, and a portable device, the terminal device may communicate with one or more core networks through a radio access network (RAN), for example, the terminal device may be a mobile phone (or a “cellular” telephone), a computer having the wireless communication capability, etc., and the terminal device may also be portable, pocket-sized, handheld, computer-built-in, or in-vehicle mobile device or other devices.

In the following method embodiment, for ease of illustration, only the execution subject of each step as the terminal device is used for introduction.

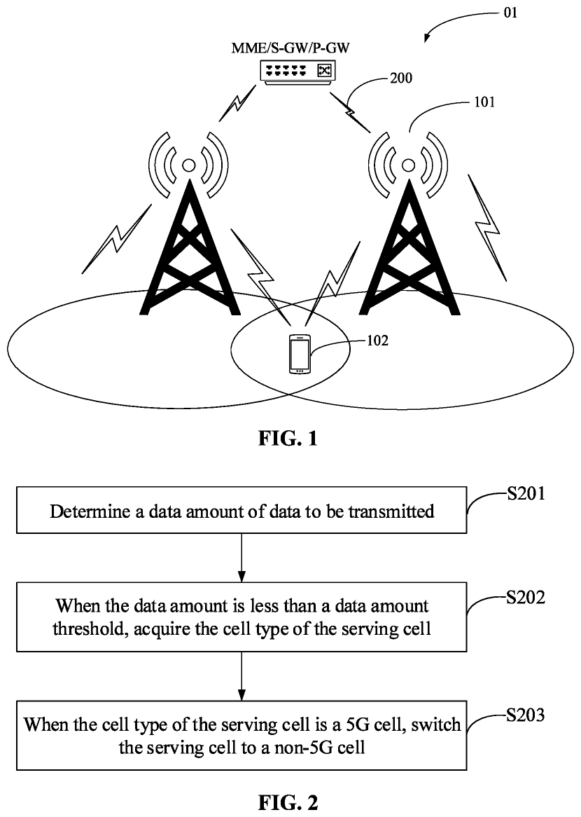

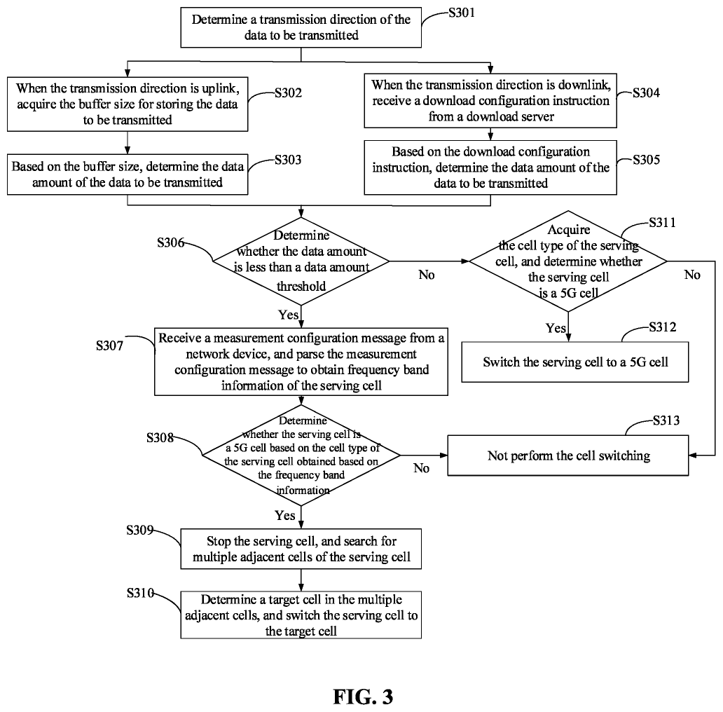

The cell switching method provided by the embodiments of the present application is described in detail combined with FIGS. 2 to 3 as follows.

Referring to FIG. 2, FIG. 2 is a schematic diagram of the flow of a cell switching method provided by an embodiment of the present application. The method may include the following steps.

In S201, a data amount of data to be transmitted is determined.

Generally, the data to be transmitted refers to data to be transmitted between a data source and a data host, this process is called data communication, and the data to be transmitted includes one or more of file data, picture data, audio data, video data, and the like. The data amount may refer to the size of a memory space occupied by the data, the data transmission of the terminal device includes two forms of uplink and downlink, the buffer size of the data to be transmitted may be detected in the case of the uplink; the received instruction signal may be parsed in the case of the downlink, and the packet size of the data required to be received is determined based on the received instruction signal. The terminal device may also determine the data amount of the data to be transmitted by counting the data amount of data transmitted in a past period of time, for example, the terminal device counts the data amount of data transmitted within 20 s as 500 M, and the data amount of the data to be transmitted within 20 s is determined to be 500 M.

In S202, when the data amount is less than a data amount threshold, the cell type of the serving cell is acquired.

Generally, the data amount threshold refers to a critical value used to determine whether to perform 5G-cell switching, since the theoretical network speed of the second-generation mobile networks (2G) is 150 kbps, equivalent to a download speed of 15-20 K/s, the 2G network is generally defined that the information such as email, and software can not be directly transmitted, and the 2G network only has the technical specifications of mobile phone communications, such as calls, time, and dates. The theoretical network speed of the third generation mobile networks (3G) is 1-6 Mbps, equivalent to a download speed of 120-600 K/s, 3G services can transmit sound and data information at the same time, and the speed for this transmission is generally more than several hundred kbps. The theoretical network speed of the fourth generation mobile networks (4G) is 10-100 Mbps, equivalent to a download speed of 1.5-10 M/s, 4G can quickly transmit data, including high-quality audios, videos, images, and the like, and has the download speed of more than 100 Mbps, which can meet the requirements of almost all users for wireless services. The theoretical peak transmission speed of 5G networks may reach 10 GB/s, the current speed of 4G long term evolution (LTE) can only reach 75 Mbps, and the transmission speed of 5G networks is hundreds of times faster than that of 4G networks. In a case of a better 5G network environment, downloading a 1 GB file may be completed in 1-3 seconds, basically not more than 10 seconds. The serving cell refers to a 2G cell, a 3G cell, a 4G cell, a 5G cell, etc. However, due to various reasons, the transmission rate of each frequency band in an actual use process is very low, and the selected data amount threshold should be combined with the actual situation, for example, the data amount threshold is set to 10 G, the data amount of the data to be transmitted is determined as 5 G. The terminal device may determine the type of a serving cell by detecting the frequency band information of the serving cell, for example, the terminal device acquires the frequency range of the serving cell as in the range of 2300-2320 MHz, according to the regulations, this frequency belongs to the China Unicom time division duplexing (TDD) cell frequency band, then the serving cell is determined to be a TDD cell; alternatively, the frequency range of the serving cell acquired by the terminal device is 1755-1785 MHz, and according to the regulations, this frequency belongs to the China Telecom frequency division duplexing (FDD) cell frequency band, and the serving cell is determined to be an FDD cell.

In S203, when the cell type of the serving cell is a 5G cell, the serving cell is switched to a non-5G cell.

Generally, the terminal device detects the serving cell and determines whether the type of the serving cell is the 5G cell, if the type is not the 5G cell, there is no need to switch the serving cell; otherwise, the serving cell is switched to a non-5G network. For example, if the terminal device interrupts data transmission of the 5G cell, scans and acquires target cell information, and if the target cell is a 4G cell, the terminal device connects to the target cell. The non-5G cell refers to as a 2G cell, a 3G cell, a 4G cell, etc.

It can be seen from the above that the data amount of the data to be transmitted is determined, and when the data amount is less than the data amount threshold, the cell type of the serving cell is acquired, and when the cell type of the serving cell is the 5G cell, the serving cell is switched to the non-5G cell. By switching the 5G cell to the non-5G cell without necessary situations, the terminal device reduces the excessive power consumption caused by continuous connection to the 5G cell without considering actual requirements in the related art, which can save terminal power consumption and increase the time of endurance.

Referring to FIG. 3, FIG. 3 is a flow diagram of another cell switching method provided by an embodiment of the present application. The cell switching method may include the following steps:

In S301, a transmission direction of the data to be transmitted is determined.

Generally, the transmission direction refers to the direction of the terminal device transmitting the data, including the uplink direction in which the terminal device sends information to the network device or a terminal device, and the downlink direction in which information is received from the network device or a terminal device. The data transmitted by the terminal device is transmitted in the form of data packets, and the data to be transmitted includes file data, audio data, video data, etc.

S302, when the transmission direction is uplink, the buffer size for storing the data to be transmitted is acquired.

Generally, the uplink refers to that the terminal device sends data in a storage area in the form of electromagnetic waves through a transmitting antenna, the buffer refers to a storage space created by the terminal device when the data is converted into electrical signals, and the terminal may detect the storage space to determine the size of the transmitted data, for example, the storage space size for the transmitted data of files is detected to be 2 G, and the storage space size for the transmitted data of videos is detected to be 10 G.

In S303, the data amount of the data to be transmitted is determined based on the buffer size.

Generally, the terminal device may determine the data amount during uplink data transmission by detecting the buffer size, for example, it is detected that the storage space size for transmitted data of videos is 40 G, and it is determined that the amount of video data is 40 G.

In S304, when the transmission direction is downlink, a download configuration instruction is received from a download server.

Generally, the downlink refers to that the terminal device receives data transmitted from the network device or a terminal device. The download server is a server that stores various data and may acquire the required data by sending a download request instruction. Message instruction transmission is performed between the terminal device and the download server, the type of data that needs to be downloaded is determined, then the download configuration instruction, including the data amount, data name, data type, etc., is received from the download server, and relevant configuration is performed, such as opening a suitable storage area, and sending a file type conversion instruction.

In S305, the data amount of the data to be transmitted is determined based on the download configuration instruction.

Generally, the terminal device parses the received download configuration instruction to determine the data amount of the data to be transmitted, and the download configuration instruction contains the data amount information about the data to be transmitted.

In S306, it is determined whether the data amount is less than the data amount threshold.

Generally, the data amount threshold is used to determine whether the terminal device needs to transmit data through a 5G cell, if the data amount is very small, there is no need to transmit data through the 5G cell, a 4G cell may satisfy the transmission data requirements, for example, the transmitted data amount is 5 G, the data amount threshold is 1 G, it is determined that the data amount of the data to be transmitted is greater than the data amount threshold, and the terminal device needs to transmit the data through the 5G cell.

S307, a measurement configuration message is received from a network device, and the measurement configuration message is parsed to obtain frequency band information of the serving cell.

Generally, the terminal device receives the measurement configuration message sent by the network device, and measurement configuration parameters in the measurement configuration message include one or more of a measurement object, a cell list, a reporting mode, a measurement identifier, an event parameter, and the like. The terminal device measures the serving cell according to the measurement configuration message described above to further obtain a signaling message frequencyBandIndicator cell, and an indication of a frequency band to which the target cell belongs may be determined according to the frequencyBandIndicator cell. For example, if the parameter configuration indicated by the frequency band of the target cell obtained through measurement of the terminal device is Band40, the corresponding frequency range of the target cell may be known as 2300-2400 MHz according to the regulations.

S308, the cell type of the serving cell is obtained based on the frequency band information to determine whether the serving cell is a 5G cell.

Generally, the frequency band of 5G includes 3300-3400 MHz (in principle, it is limited for indoor use), 3400-3600 MHz, and 4800-5000 MHz. The frequency band of 4G includes 1880-1900 MHz, 2320-2370 MHz, and 2575-2635 MHz. The frequency band of 3G includes 1880-1900 MHz and 2010-2025 MHz. For example, when the terminal device detects that the frequency range of the target cell is 2300-2400 MHz, it is determined that the target cell is a non-5G cell.

S309, the serving cell is stopped, and multiple adjacent cells of the serving cell are searched.

Generally, the terminal device first stops transmitting data through the serving cell, searches for multiple adjacent cells of the serving cell, determines the target cell identifier, and then connects to the target cell.

S310, the target cell in the multiple adjacent cells is determined, and the serving cell is switched to the target cell.

Generally, the terminal device parses the measurement configuration message to determine the data parameters of the network device that the terminal device needs to obtain. The measurement result includes reference signal receiving power (RSRP), reference signal receiving quality (RSRQ), a path loss, etc. The higher the RSRP value is, the stronger the signal quality strength is, and the terminal device obtains the RSRP of multiple adjacent cells, determines a cell having the largest RSRP value as the target cell, and connects to the target cell. For example, the terminal device scans and parses the measurement configuration message to obtain a cell list, and the cell list includes a cell identifier (Cell ID) obtained by scanning, an RSRP value, a frequency band, and other information. For Cell1, the Cell ID is 009, the RSRP is −60 dBm, and the frequency band is 2575-2635 MHz, for Cell2, the Cell ID is 010, the RSRP is −90 dBm, and the frequency band is 2575-2635 MHz. From the cell list information, it can be seen that both cells are 4G cells, but the RSRP value in Cell1 is greater than the RSRP value in Cell2, so the terminal device determines that Cell1 is the target cell.

In S311, the cell type of the serving cell is obtained and it is determined whether the serving cell is a 5G cell.

Generally, the terminal device obtains the frequency band information of the serving cell, and determines whether the serving cell is a 5G cell based on the frequency band information, for example, it is detected that the frequency range of the serving cell is 4800-5000 MHz and it is determined that the cell type of the serving cell is the 5G cell.

In S312, the serving cell is switched to a 5G cell.

Generally, the terminal device stops transmitting data through the serving cell, and the corresponding configuration is performed for stopping the data transmission through the 5G cell.

In S313, cell switching is not performed.

Generally, the terminal device transmitting data through the serving cell satisfies the load requirements for transmitting the current data amount, so there is no need to perform the cell switching.

When the scheme of the embodiments of the present application is executed, the transmission direction of the data to be transmitted is determined, when the transmission direction is uplink, the buffer size for storing the data to be transmitted is acquired, and the data amount of the data to be transmitted is determined based on the buffer size; and when the transmission direction is downlink, a download configuration instruction is received from the download server, and the data amount of the data to be transmitted is determined based on the download configuration instruction. It is determined whether the data amount is less than the data amount threshold, if the data amount is not less than the data amount threshold, the cell type of the serving cell is acquired, and it is determined whether the serving cell is a 5G cell. If the serving cell is the non-5G cell, the serving cell is switched to the 5G cell; otherwise, cell switching is not performed. If the data amount is not less than the data amount threshold, the measurement configuration message is received from the network device, the measurement configuration message is parsed to obtain the frequency band information of the serving cell, the cell type of the serving cell is obtained based on the frequency band information, it is determined whether the serving cell is the 5G cell, if the serving cell is the 5G cell, the serving cell is stopped, multiple adjacent cells of the serving cell are searched for, the target cell in the multiple adjacent cells is determined, and the current serving cell is switched to the target cell; otherwise, the cell switching is not performed. By switching the 5G cell to the non-5G cell without necessary situations, the terminal device reduces the excessive power consumption caused by continuous connection to the 5G cell without considering actual requirements in the related art, which can save terminal power consumption and increase the time of endurance.

The following is an apparatus embodiment of the present application, and the apparatus may be configured to execute the method embodiment of the present application. For details not disclosed in the apparatus embodiment of the present application, please refer to the method embodiment of the present application.

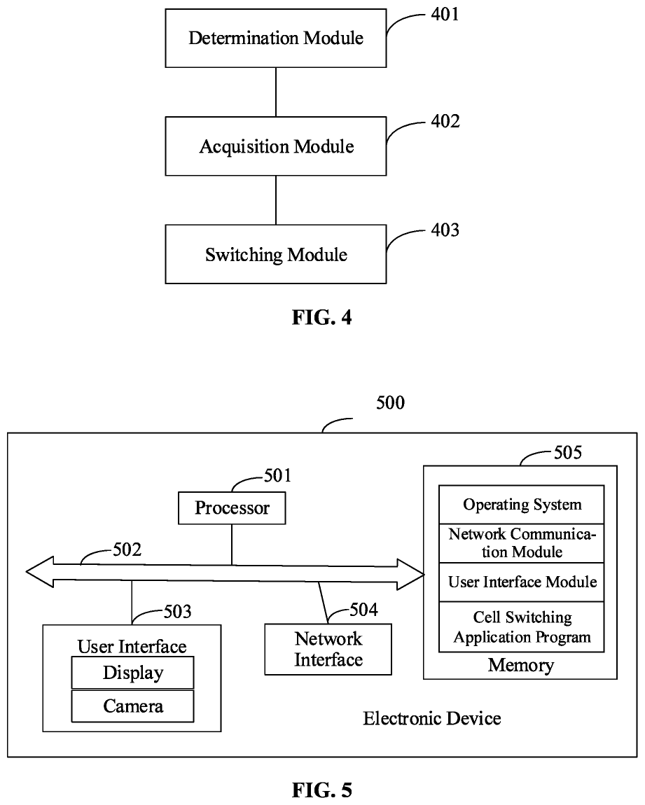

Referring to FIG. 4, FIG. 4 shows a schematic diagram of the structure of a cell switching apparatus provided by an example embodiment of the present application, hereinafter referred to as a control apparatus 4. The control apparatus 4 may be implemented by software, hardware, or a combination of the two to become all or part of the terminal. The control apparatus includes a determination module 401, an acquisition module 402, and a switching module 403.

The determination module 401 is configured to determine a data amount of data to be transmitted.

The acquisition module 402 is configured to acquire a cell type of a serving cell when the data amount is less than the data amount threshold.

The switching module 403 is configured to switch the serving cell to a non-5G cell when the cell type of the serving cell is a 5G cell.

In an embodiment, the determination module 401 further includes a transmission unit.

The transmission unit is configured to determine a transmission direction of the data to be transmitted; when the transmission direction is uplink, the transmission unit is configured to acquire a buffer size for storing the data to be transmitted and determine the data amount of the data to be transmitted based on the buffer size; or when the transmission direction is downlink, the transmission unit is configured to receive a download configuration instruction from a download server and determine the data amount of the data to be transmitted based on the download configuration instruction.

In an embodiment, the acquisition module 402 further includes a reception unit.

The reception unit is configured to receive a measurement configuration message from a network device, parse the measurement configuration message to obtain frequency band information of the serving cell, and obtain the cell type of the serving cell based on the frequency band information.

In an embodiment, the switching module 403 further includes a scanning unit and a determination unit.

The scanning unit is configured to: stop the serving cell, search for a plurality of adjacent cells of the serving cell, where the plurality of adjacent cells belongs to a non-5G network; determine a target cell in the plurality of adjacent cells; switch the current serving cell to the target cell; acquire reference signal receiving power of the plurality of adjacent cells; and determine a cell having the largest RSRP value as the target cell.

The determination unit is configured to acquire the cell type of the serving cell when the data amount is not less than the data amount threshold; when the cell type of the serving cell is the 5G cell, not perform cell switching; or when the cell type of the serving cell is a non-5G cell, switch the serving cell to a 5G cell.

Embodiments of the present application and the method embodiments of FIGS. 2 to 3 are based on the same idea, and the technical effects brought by them are also the same, the specific process may refer to the description of the method embodiments of FIGS. 2 to 3, which will not be repeated herein.

The apparatus 4 may be a field-programmable gate array (FPGA), a specific-integrated chip, a system on chip (SoC), a central processor unit (CPU), a network processor (NP), a digital signal processing circuit, a micro controller unit (MCU) for implementing the relevant functions, and the apparatus may also use a programmable logic device (PLD) or other integrated chips.

When the scheme of the embodiments of the present application is executed, the transmission direction of the data to be transmitted is determined, when the transmission direction is uplink, the buffer size for storing the data to be transmitted is acquired, the data amount of the data to be transmitted is determined based on the buffer size, when the transmission direction is downlink, a download configuration instruction is received from the download server, the amount of the data to be transmitted is determined based on the download configuration instruction, it is determined whether the data amount is less than the data amount threshold, if the data amount is not less than the data amount threshold, the cell type of the serving cell is acquired, and it is determined whether the serving cell is a 5G cell. If the serving cell is the 5G cell, the serving cell is switched to a 5G cell; otherwise, cell switching is not performed.

If the data amount is not less than the data amount threshold, the measurement configuration message is received from the network device, the measurement configuration message is parsed to obtain the frequency band information of the serving cell, the cell type of the serving cell is obtained based on the frequency band information, it is determined whether the serving cell is a 5G cell, if the serving cell is the 5G cell, the serving cell is stopped, a plurality of adjacent cells of the serving cell are searched for, a target cell in the plurality of adjacent cells is determined, and the current serving cell is switched to the target cell; otherwise, the cell switching is not performed. By switching the 5G cell to the non-5G cell without necessary situations, the terminal device reduces the excessive power consumption caused by continuous connection to the 5G cell without considering actual requirements in the related art, which can save terminal power consumption and increase the time of endurance.

An embodiment of the present application also provides a computer storage medium, the computer storage medium may store a plurality of instructions, the instructions are suitable for loading by the processor and performing the method steps described above, and an execution process may refer to the description of the embodiment shown in FIG. 2 or FIG. 3, which is not described herein.

The present application further provides a computer program product storing at least one instruction, the at least one instruction is loaded and executed by the processor to implement the control method of the template described in each embodiment above.

Referring to FIG. 5, FIG. 5 is a schematic diagram of an electronic device provided by an embodiment of the present application. As shown in FIG. 5, the electronic device 5 may include at least one processor 501, at least one network interface 504, a user interface 503, a memory 505, and at least one communication bus 502.

The communication bus 502 is used to realize connection communications among these components.

The user interface 503 may include a display and a camera, and the user interface 503 may also include a standard wired interface and a wireless interface.

The network interface 504 may include a standard wired interface and a wireless interface (such as a wireless fidelity (Wi-Fi) interface).

The processor 501 may include one or more processing cores. The processor 501 uses various interfaces and lines to connect the components of the entire terminal 500, and the processor 501 performs various functions and processes data by performing or executing instructions, programs, code sets or instruction sets stored in the memory 505 and by calling data stored in the memory 505. Alternatively, the processor 501 may be implemented in at least one hardware form of a digital signal processing (DSP), a field-programmable gate array (FPGA), or a programmable logic array (PLA). The processor 501 may integrate one or more combinations of a central processing unit (CPU), a graphics processing unit (GPU), a modem, and so on. Among them, the CPU mainly handles the operating system and the user interfaces and applications, the GPU is responsible for rendering and drawing the content required to be displayed by the display, and the modem is used to handle wireless communications. It can be understood that the above modem may also be implemented without being integrated into the processor 501 and implemented by a single chip.

The memory 505 may include a random access memory (RAM), and may also include a read-only memory. In an embodiment, the memory 505 includes a non-transitory computer-readable storage medium. The memory 505 may be used to store instructions, programs, codes, code sets, or instruction sets. The memory 505 may include a stored program area and a storage data area, where the stored program area may store instructions for implementing the operating system, instructions for at least one function (such as the touch function, the sound playback function, the image playback function, etc.), instructions for implementing each embodiment of the above methods, and the like. The storage data area may store data involved in each embodiment of the above methods. The memory 505 may also be at least one storage device located far away from the processor 501. As shown in FIG. 5, as a computer storage medium, the memory 505 may include the operating system, a network communication module, a user interface module, and a cell switching application.

In the electronic device 500 shown in FIG. 5, the user interface 503 is mainly configured to provide an input interface for a user and obtain user input data. The processor 501 may be used to call the cell switching application program stored in the memory 505, and the processor 501 is configured to execute the following:
an amount of data to be transmitted is determined;
when the data amount is less than the data amount threshold, a cell type of a serving cell is acquired; and
when the cell type of the serving cell is a 5G cell, the serving cell is switched to a non-5G cell.

In an embodiment, the processor 501 is configured to further execute the following:
when the data amount is not less than the data amount threshold, the cell type of the serving cell is acquired;
when the cell type of the serving cell is the 5G cell, cell switching is not performed; or
when the cell type of the serving cell is a non-5G cell, the serving cell is switched to a 5G cell.

In an embodiment, the processor 501 executes determining the data amount of the data to be transmitted by the following:
determining a transmission direction of the data to be transmitted;
when the transmission direction is uplink, acquiring the buffer size for storing the data to be transmitted;
determining the data amount of the data to be transmitted based on the buffer size; or
when the transmission direction is downlink, receiving a download configuration instruction from a download server; and
determining the data amount of the data to be transmitted based on the download configuration instruction.

In an embodiment, the processor 501 executes acquiring the cell type of the serving cell by the following:
receiving a measurement configuration message from a network device;
parsing the measurement configuration message to obtain frequency band information of the serving cell; and
obtaining the cell type of the serving cell based on the frequency band information.

In an embodiment, the processor 501 executes switching the serving cell to the non-5G cell by the following:
stopping the serving cell;
searching for multiple adjacent cells of the serving cell; where the multiple adjacent cells belong to a non-5G network;
determining a target cell in the multiple adjacent cells; and
switching the current serving cell to the target cell.

In an embodiment, the processor 501 executes determining the target cell in the multiple adjacent cells by the following:
acquiring RSRP of the multiple adjacent cells; and
determining a cell having the largest RSRP value as the target cell.

The technical conception of the embodiment of the present application is the same as the technical conception of FIG. 2 or FIG. 3, and the process may refer to the method embodiment of FIG. 2 or FIG. 3, which is not repeated herein.

In embodiments of the present application, the transmission direction of the data to be transmitted is determined, when the transmission direction is uplink, the buffer size for storing the data to be transmitted is acquired, the data amount of the data to be transmitted is determined based on the buffer size; and when the transmission direction is downlink, a download configuration instruction is received from the download server, and the data amount of the data to be transmitted is determined based on the download configuration instruction. It is determined whether the data amount is less than the data amount threshold, if the data amount is not less than the data amount threshold, the cell type of the serving cell is acquired, and it is determined whether the serving cell is a 5G cell, if the serving cell is the non-5G cell, the serving cell is switched to a 5G cell; and if the serving cell is a non-5G cell, the cell switching is not performed. If the data amount is less than the data amount threshold, a measurement configuration message is received from a network device, the measurement configuration message is parsed to obtain frequency band information of the serving cell, the cell type of the serving cell is obtained based on the frequency band information, it is determined whether the serving cell is a 5G cell, if the serving cell is a 5G cell, the serving cell is stopped, multiple adjacent cells of the serving cell are searched for, a target cell in the multiple adjacent cells is determined, and the current serving cell is switched to the target cell; and if the serving cell is a non-5G cell, cell switching is not performed. By switching a 5G cell to a non-5G cell without necessary situations, the terminal device reduces the excessive power consumption caused by continuous connection to the 5G cell without considering actual needs in the related art, and the terminal power consumption can be saved and the time of endurance can be increased.

Those of ordinary skill in the art may understand that the process of implementing all or part of the above embodiment methods may be completed by a computer program instructing the relevant hardware, the program may be stored in a computer-readable storage medium, and when the program is executed, the program may include a process of embodiments such as the above methods. The storage medium may be a disk, an optical disk, a read-only storage memory or a random storage memory, etc.

The above disclosure is only a better embodiment of the present application, of course, it cannot be used to limit the scope of the claims of the present application, so the equivalent alternatives made according to the claims of the present application are still within the scope of the present application.

What is claimed is:

1. A cell switching method, comprising:
determining a data amount of data to be transmitted;
in a case where the data amount is less than a data amount threshold, acquiring a cell type of a serving cell; and
in a case where the cell type of the serving cell is a fifth-generation mobile communication technology (5G) cell, switching the serving cell to a non-5G cell.

2. The method according to claim 1, further comprising:
in a case where the data amount is not less than the data amount threshold, acquiring the cell type of the serving cell;
in a case where the cell type of the serving cell is a 5G cell, not performing cell switching; or
in a case where the cell type of the serving cell is a non-5G cell, switching the serving cell to a 5G cell.

3. The method according to claim 1, wherein determining the data amount of data to be transmitted comprises:
determining a transmission direction of the data to be transmitted;
in a case where the transmission direction is uplink, acquiring a buffer size for storing the data to be transmitted;
determining the data amount of the data to be transmitted based on the buffer size; or
in a case where the transmission direction is downlink, receiving a download configuration instruction from a download server; and
determining the data amount of the data to be transmitted based on the download configuration instruction.

4. The method according to claim 1, wherein acquiring the cell type of the serving cell comprises:
receiving a measurement configuration message from a network device;
parsing the measurement configuration message to obtain frequency band information of the serving cell; and
obtaining the cell type of the serving cell based on the frequency band information.

5. The method according to claim 1, wherein switching the serving cell to the non-5G cell comprises:
stopping the serving cell;
searching for a plurality of adjacent cells of the serving cell, wherein the plurality of adjacent cells belong to a non-5G network;
determining a target cell in the plurality of adjacent cells; and
switching the current serving cell to the target cell.

6. The method according to claim 1, wherein determining the target cell in the plurality of adjacent cells comprises:
acquiring reference signal received powers (RSRPs) of the plurality of adjacent cells; and
determining a cell having a largest RSRP in the RSRPs as the target cell.

7. The method according to claim 1, wherein the non-5G cell comprises: a fourth-generation mobile communication technology (4G) cell, a third-generation mobile communication technology (3G) cell, or a second-generation mobile communication technology (2G) cell.

8. A cell switching apparatus, comprising:
a determination module, which is configured to determine a data amount of data to be transmitted;
an acquisition module, which is configured to acquire a cell type of a serving cell, in a case where the data amount is less than a data amount threshold; and
a switching module, which is configured to switch the serving cell to a non-fifth-generation mobile communication technology (5G) cell, in a case where the cell type of the serving cell is a 5G cell.

9. A non-transitory computer storage medium, storing a plurality of instructions, wherein the plurality of instructions are suitable for being loaded by a processor and executing a method step of claim 1.

10. An electronic device, comprising: a memory and a processor; wherein the memory stores a computer program, and the computer program is suitable for being loaded by the processor and executing the following:
determining a data amount of data to be transmitted;
in a case where the data amount is less than a data amount threshold, acquiring a cell type of a serving cell; and
in a case where the cell type of the serving cell is a fifth-generation mobile communication technology (5G) cell, switching the serving cell to a non-5G cell.

11. The electronic device according to claim 10, wherein the computer program is configured to further execute the following:
in a case where the data amount is not less than the data amount threshold, acquiring the cell type of the serving cell;
in a case where the cell type of the serving cell is a 5G cell, not performing cell switching; or
in a case where the cell type of the serving cell is a non-5G cell, switching the serving cell to a 5G cell.

12. The electronic device according to claim 10, wherein the computer program is configured to execute determining the data amount of data to be transmitted by:
determining a transmission direction of the data to be transmitted;
in a case where the transmission direction is uplink, acquiring a buffer size for storing the data to be transmitted;
determining the data amount of the data to be transmitted based on the buffer size; or
in a case where the transmission direction is downlink, receiving a download configuration instruction from a download server; and
determining the data amount of the data to be transmitted based on the download configuration instruction.

13. The electronic device according to claim 10, wherein the computer program is configured to execute acquiring the cell type of the serving cell by:
receiving a measurement configuration message from a network device;
parsing the measurement configuration message to obtain frequency band information of the serving cell; and
obtaining the cell type of the serving cell based on the frequency band information.

14. The electronic device according to claim 10, wherein the computer program is configured to execute switching the serving cell to the non-5G cell by:
stopping the serving cell;
searching for a plurality of adjacent cells of the serving cell, wherein the plurality of adjacent cells belong to a non-5G network;
determining a target cell in the plurality of adjacent cells; and
switching the current serving cell to the target cell.

15. The electronic device according to claim 10, wherein the computer program is configured to execute determining the target cell in the plurality of adjacent cells by:
acquiring reference signal received powers (RSRPs) of the plurality of adjacent cells; and
determining a cell having a largest RSRP in the RSRPs as the target cell.

16. The electronic device according to claim 10, wherein the non-5G cell comprises: a fourth-generation mobile communication technology (4G) cell, a third-generation mobile communication technology (3G) cell, or a second-generation mobile communication technology (2G) cell.

17. The storage medium according to claim 9, wherein the plurality of instructions are configured to further execute:
in a case where the data amount is not less than the data amount threshold, acquiring the cell type of the serving cell;
in a case where the cell type of the serving cell is a 5G cell, not performing cell switching; or
in a case where the cell type of the serving cell is a non-5G cell, switching the serving cell to a 5G cell.

18. The storage medium according to claim 9, wherein the plurality of instructions are configured to execute determining the data amount of data to be transmitted by:
determining a transmission direction of the data to be transmitted;
in a case where the transmission direction is uplink, acquiring a buffer size for storing the data to be transmitted;
determining the data amount of the data to be transmitted based on the buffer size; or
in a case where the transmission direction is downlink, receiving a download configuration instruction from a download server; and
determining the data amount of the data to be transmitted based on the download configuration instruction.

19. The storage medium according to claim 9, wherein the plurality of instructions are configured to execute acquiring the cell type of the serving cell by:
receiving a measurement configuration message from a network device;
parsing the measurement configuration message to obtain frequency band information of the serving cell; and
obtaining the cell type of the serving cell based on the frequency band information.

20. The storage medium according to claim 9, wherein the plurality of instructions are configured to execute switching the serving cell to the non-5G cell by:
stopping the serving cell;
searching for a plurality of adjacent cells of the serving cell, wherein the plurality of adjacent cells belong to a non-5G network;
determining a target cell in the plurality of adjacent cells; and
switching the current serving cell to the target cell.
